(19) United States
(12) Patent Application Publication
(10) Pub. No.: US 2009/0109367 A1
(43) Pub. Date: Apr. 30, 2009

(54) Flat display panel with special surface design

(76) Inventors: James Chu, Taipei (TW); H.C. HO, Taipei (TW)

Correspondence Address: BIRCH STEWART KOLASCH & BIRCH, PO BOX 747, FALLS CHURCH, VA, 22040-0747, US

(21) Appl. No.: 11/980,468

(22) Filed: Oct. 31, 2007

(51) Int. Cl. G02F 1/1333

(52) U.S. Cl. 349/58

(57) ABSTRACT

This invention is to reveal a kind of flat display panel, in particular a kind of flat display panel with special surface design including at least a flat display panel main body, the top having a front view frame, the said front frame can fix an LC display panel inside the front view frame; a base, installed at the bottom of the said flat display panel main body, through the base the said flat display panel main body can be firmly installed on flat surface; and a 3D pattern having flat, regular or irregular indentation patterns that could defect light and installed on the outer surface of the said front view frame product.

### FIELD OF THE INVENTION

This invention is regarding a kind of flat display panel, in particular a kind of flat display panel with special surface design.

### BACKGROUND OF THE INVENTION

The LC flat display panels sold in the market are no other than using resin directly injected mold outer frame assembled with LCD panel, polarizer, and backlight, etc. to complete a flat display panel. The most is to roast paint the outer frame or to try as much to combine panel and outer frame into one body so as to make the flat display panel looks versatile in order to stimulate buyer's purchasing desire.

However, the design of above mentioned flat panel is too simple, conventional, and all too familiar to the public and indeed could not attract the eyes of general consumer. To user with creativity and personality this really could not stimulate their purchasing desire, hence affecting the sales of manufacturer's product.

In view of the issues of conventional technology, this invention proposes a kind of flat display panel with special surface design to resolve the problem existing in the conventional technology.

### SUMMARY OF THE INVENTION

The main purpose of this invention is to propose a kind of flat display panel with special surface design, which is using a kind of 3D pattern installed on the front view surface of flat display panel in flat regular or irregular indentation outlook, through the said special creation the light is reflected and achieves the objective of attracting consumer.

Another objective of this invention is in providing a kind of flat display panel with a special surface design that could install the said flat regular or irregular indentation design on the surface of projecting display device that could also achieve the effect of decoration.

To achieve the above stated objectives, this invention is to reveal a kind of flat display panel, in particular a flat display panel with special surface designs, including at least a flat display panel main body, the top is having a front view outer frame, the said front view outer frame can be installed with an LC display panel into the said front view outer frame; a base, installed at the bottom of the said flat display panel main body, through the said base the said flat display panel main body is firmly installed on the flat surface; and a 3D pattern, having the look of indentation that could cause light to reflect, installed on the surface of the said front view outer frame and the said base, meeting the requirement of consumer with taste and can be used extensively for industrial utilization and is very suitable for mass production.

Below is the description of embodiment of the invention with attached diagrams, which should be easy to understand the objectives, technical content, and features, and effects, created by this invention.

### BRIEF DESCRIPTION OF THE DRAWINGS

FIG. 1 is the 3D diagram of the flat display panel of this invention with special surface design of this invention.

FIG. 2 is one of the examples of the embodiment of the 3D pattern of this invention.

FIG. 3 is another example of the embodiment of the 3D pattern of this invention.

FIG. 4 is the protruding structure of the 3D pattern of this invention.

FIG. 5 is the depressed structure of the 3D pattern of this invention.

FIG. 6 is still another example of the embodiment of the 3D pattern of this invention.

### DETAILED DESCRIPTION OF THE PREFERRED EMBODIMENTS

In order for your auditing committee to clearly, understand other characteristic content of this invention and advantage as well as manifestation of the function achieved, the present invention together with its diagrams are described in detail as follow:

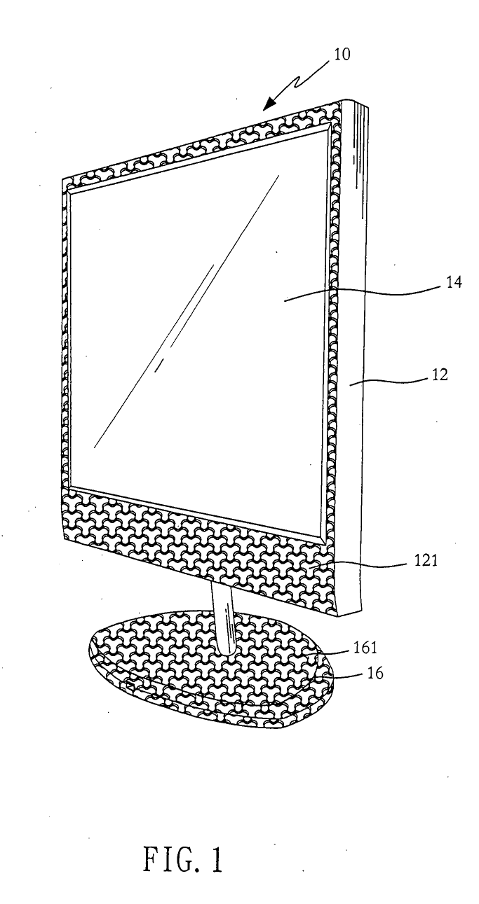

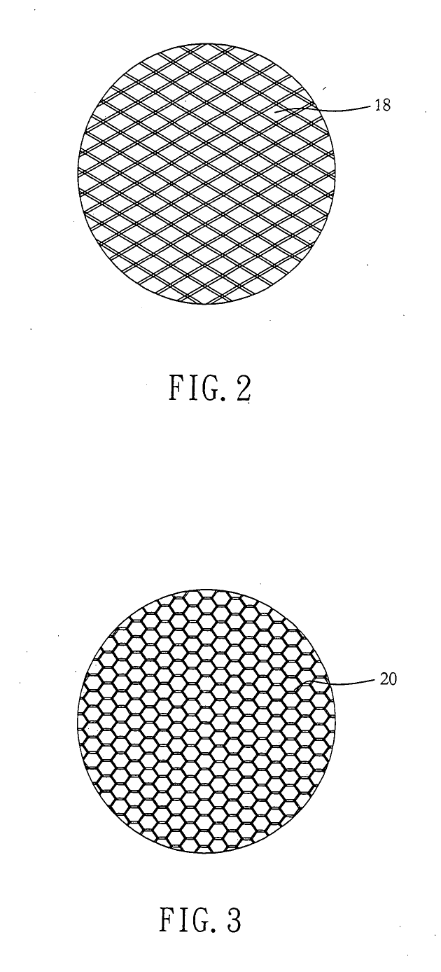

FIG. 1 is the 3D diagram of the flat display panel of this invention with special surface design and FIG. 2 is an example of the embodiment of the 3D pattern of this invention. As illustrated in the figures, a flat display panel main body 10, the top of the said display is installed with a front view outer frame 12 that could install an LC display panel 14 into the interior of the said front view outer frame 12, a base 16 installed beneath the main body 10 of the flat display panel, through base 16 the flat display panel main body 10 could be installed on flat surface; and 3D patterns 121 and 161, using the regular or irregular outlook of flat-indentation causing light to reflect installed on the surface of the said front view outer frame 12 and the said base 16. Whereas the said 3D pattern could also be installed on the surface of a projector as a kind of appearance of special design that could effectively attract consumer to purchase.

FIG. 2 is an example of embodiment of the 3D pattern of this invention. As shown in the diagram, the said 3D patterns 121 and 161 can be a quadrilateral form 18 installed sequentially.

Again please refer to FIG. 3, which is another example of embodiment of the 3D pattern of this invention, the said 3D patterns 121 and 161 is installed in the polygon form 20 that could effectively achieve the design feature of different changes.

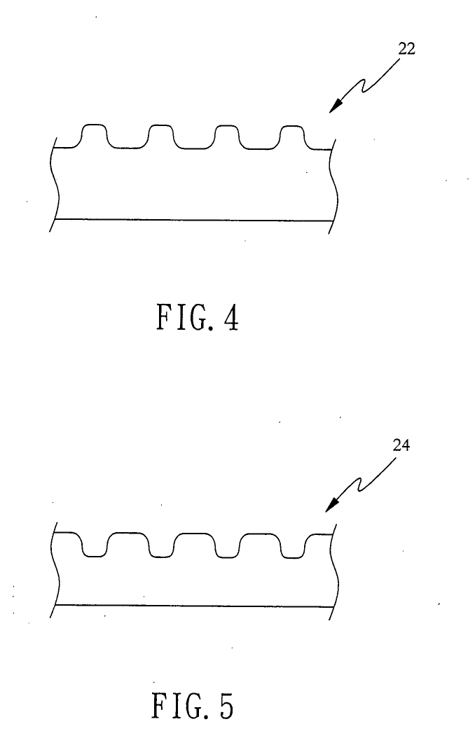

The surface of 3D patterns 121 and 161 can be the same as the protruding structure of the 3D pattern of this invention as shown in FIG. 4, with the protruding surface 22 generating indentation design, and further the light source could reflect light through the protruding surface 22 and installed on the surface of the front view outer frame 12 and the said based 16.

Please again refer to the FIG. 5, which shows the depressed structural diagram of the 3D pattern of this invention. As shown in the figure, the surface of 3D pattern 121 and 161 generates indentation outlook of depressed surface 24 and further allows light source to reflect through the depressed surface 24 and installed on the surface of front view outer frame 12 and the said base 16 to achieve the same effect, which is very suitable for the consumer with taste and has extreme industrial usability and very suitable for mass production.

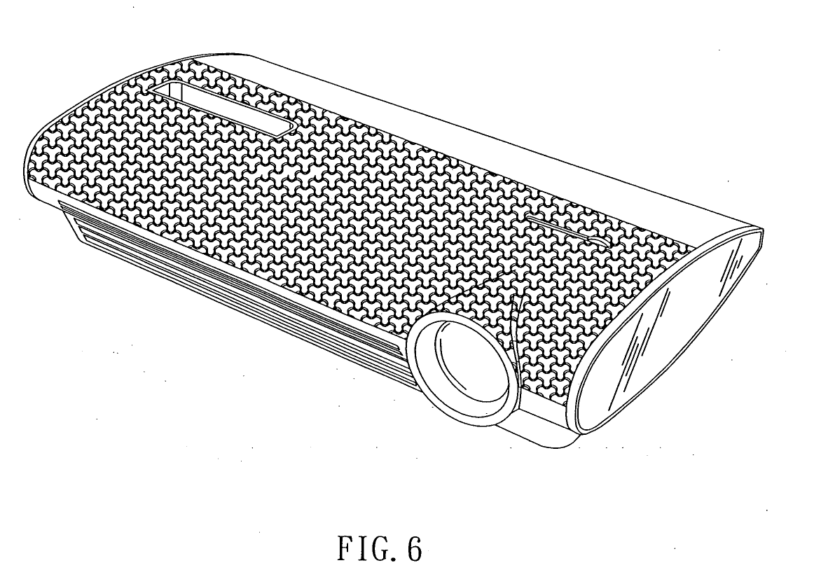

Please once again refer to FIG. 6 which is still another example of embodiment of the 3D pattern of this invention, a projector 26, on the surface of the said projector 26 is installed with a flat surface regular and irregular indentation with 3D pattern 261 that could make the appearance of projector 26 having looks of quality and features, or to install on the outlook of TV or OLCD display (not shown in the figure) to achieve similar effect.

In summary, this invention through the breakthrough of prior technological structure has indeed achieved the effect of desired advancement and is not possibly achieved by persons familiar with the said art. Further, this invention has never been published previously and the advancement and practicality it has obviously could meet the prerequisite of patent application. Thereby apply for the invention and hope your authority could approve the patent application of this invention for the encouragement of this invention.

The embodiment described above is just for the description of the technical thought and features of this invention. The purpose is for people familiar with such art to understand the content of this invention for implementation and should not be restricted to the range of patent of this invention. All the equivalent changes or modifications based on the spirit revealed by this invention should still be covered by in the patent range of this invention.

What is claimed is:

1. A kind of flat display panel with special surface design, including at least:
A flat display panel main body, with a front view outer frame at top, the said front view outer frame could install an LC display panel fixed in the said front view outer frame;
A base, installed beneath the said flat display panel main body, through the said base the flat display panel main body could be fixed on the flat surface; and
A 3D pattern, deflecting light using flat indentation with regular or irregular outlook design, installed on the surface of the said front view outer frame and the said base.

2. As stated in claim 1 of the flat display with special surface design, where the said 3D pattern can further installed on the surface of a projector.

3. As stated in claim 1 of the flat display with special surface design, where the said 3D pattern can be in the form of quadrilateral form.

4. As stated in claim 1 of the flat display with special surface design, where the said 3D pattern can be in the form of polygon.

5. As stated in claim 1 of the flat display with special surface design, where the said 3D pattern is installed on the surface of the said front view outer frame and the said base.

6. As stated in claim 1 of the flat display with special surface design, where the said 3D pattern is a depressed surface design, installed on the surface of the said front view outer frame and the said base.

7. As stated in claim 1 of the flat display with special surface design, where the said 3D pattern can be installed on the surface of a TV.

8. As stated in claim 1 of the flat display with special surface design, where the said 3D pattern can be installed on the surface of a OLCD display.
